(19) United States
(12) Patent Application Publication
(10) Pub. No.: US 2020/0173406 A1
(43) Pub. Date: Jun. 4, 2020

(54) USE OF GASEOUS FUEL IN MARINE VESSELS

(71) Applicant: WÄRTSILÄ FINLAND OY, Vaasa (FI)

(72) Inventors: Klaus WIDJESKOG, Vaasa (FI); Mathias JANSSON, Vaasa (FI)

(73) Assignee: Wärtsilä Finland Oy, Vaasa (FI)

(21) Appl. No.: 16/282,347

(22) PCT Filed: Aug. 23, 2016
(86) PCT No.: PCT/FI2016/050575

§ 371 Date: Feb. 22, 2019

(51) Int. Cl. F02M 37/00; B63H 21/38; F01N 3/02

(52) U.S. Cl. CPC F02M 37/0011; F01N 3/0205; B63H 21/38

(57) ABSTRACT

A marine vessel includes at least one gas fuel consumer is arranged at a first horizontal level in the vessel, and at least one gas tank for the gas fuel consumer is arranged at a second horizontal level in the vessel, which second horizontal level is different from the first horizontal level. The vessel is provided with a fluid passing shaft for providing a confined vertically extending shaft between a gas consumer at a first horizontal level in the vessel and at least one gas fuel tank arranged at a second horizontal level in the vessel.

### RELATED APPLICATION

This application claims priority as a continuation application under 35 U.S.C. § 120 to PCT/FI2016/050575 filed as an International Application on Aug. 23, 2016 designating the U.S., the entire content of which is hereby incorporated by reference in its entirety.

### FIELD

The present invention relates to marine vessels, and to a fluid passing shaft for conveying multiple parallel fluid ducts in such a marine vessel between different horizontal levels in the vessel.

### BACKGROUND INFORMATION

Using gaseous fuel in marine vessels has become more and more interesting due to its capability of clean combustion and low exhaust gas emissions. On the other hand gas is very easily flammable and storing and using gas as a fuel poses an increased safety risks which are coped with various pre-cautionary measures and safety rule which must be obeyed.

Gas consumers and the gas tanks are often at different compartments in the vessel. Particularly when the gas tank is intended to store fuel gas for the gas consumer in the vessel only (i.e. is it not a cargo tank), the tanks are often arranged to a different horizontal level than the gas consumer in the vessel. A gas consumer may be a power plant for producing propulsion power to the vessel or for auxiliary equipment, so called hotel power. The gas consumer includes often an internal combustion piston engine using gaseous fuel.

WO2007147931 A1, the contents of which are hereby incorporated by reference in their entirety, is cited as an example of a fuel tank arrangement in a marine vessel. The document discloses a marine vessel operated with gaseous fuel having at least one gas powered engine provided with a fuel tank arrangement in which the fuel is stored in liquid phase. In the vessel the engine is positioned in an engine room which is provided with an engine room casing extending from the engine room to exterior of the vessel. The fuel tank arrangement is arranged in vicinity of the engine room casing. This way the tank arrangement may be located in a space which is easily ventilated upwards in the vessel.

GB 2 481 983, the contents of which are hereby incorporated by reference in their entirety, discloses a ship including a tank room for holding at least one gas storage tank, the tank room including a conduit extending from said tank room to the open air outside said ship for allowing the venting of gas in the event of a leak from a storage tank held in the tank room. The conduit may lead to open air at the top of the ship, with the upper end of the conduit substantially level with the top of any superstructure present on the ship.

US 2015/158557 A1, the contents of which are hereby incorporated by reference in their entirety, discloses a floating vessel having a body structure, a tank for storing a liquid, and at least one pipe connected to the tank. The floating vessel can include a tunnel having a first end portion and a second end portion extending through the body structure. The tunnel is arranged in open connection to an ambient environment of the floating vessel. There is at least one pipe connected to the tank extending at least partially through the tunnel.

### SUMMARY

A marine vessel is disclosed comprising: at least one gas fuel consumer arranged at a first horizontal level in the vessel; at least one gas tank for the gas fuel consumer arranged at a second horizontal level in the vessel; and a fluid passing shaft having a vertically extending part arranged to extend between the first and the second horizontal levels, wherein the fluid passing shaft includes: at least one gas conduit arranged to extend via the fluid passing shaft from the at least one gas tank to the at least one gas fuel consumer; and a laterally extending part which is arranged to at least partly support the gas consumers of the vessel.

### BRIEF DESCRIPTION OF DRAWINGS

In the following, exemplary embodiments as disclosed herein will be described with reference to the accompanying exemplary, schematic drawings, in which:

FIG. 1 illustrates a marine vessel provided with a fluid passing shaft according to an exemplary embodiment of the disclosure;

FIG. 2 illustrates a fluid passing shaft according to an exemplary embodiment of the disclosure;

FIG. 3 illustrates a marine vessel provided with a fluid passing shaft according to an exemplary embodiment of the disclosure;

FIG. 4 illustrates a marine vessel provided with a fluid passing shaft according to another exemplary embodiment of the disclosure; and

FIG. 5 illustrates a marine vessel provided with a fluid passing shaft according to still another exemplary embodiment of the disclosure.

### DETAILED DESCRIPTION

A marine vessel is disclosed in which the performance can be considerably improved compared to known solutions.

A novel arrangement in a marine vessel includes fluid ducts between different horizontal levels in the vessel which may be efficiently conveyed.

According to an exemplary embodiment of the disclosure a marine vessel is provided with at least one gas fuel consumer arranged at a first horizontal level in the vessel and at least one gas tank for the gas fuel consumer is arranged at a second horizontal level in the vessel. The vessel is provided with a fluid passing shaft arranged to extend between the first and the second horizontal levels, and the fluid passing shaft includes at least one gas conduit arranged to extend via the fluid passing shaft from the at least one gas tank to the at least one gas fuel consumer.

This can provide a very compact unit for passing various fluids between different horizontal levels in a marine vessel. Also weight and amount of piping can be minimized and thermal losses can be minimal or thermal energy exchange is made possible.

According to an exemplary embodiment of the disclosure the fluid passing shaft is a self-supporting structure.

This way the fluid passing shaft may be prefabricated and hauled as an entity to a space provided in a marine vessel.

According to an exemplary embodiment of the disclosure the fluid passing shaft is includes a vertically extending part and laterally extending part. The laterally extending part may also be referred to as a horizontally extending part.

The laterally extending part of the fluid passing shaft is arranged to at least partly support the gas consumers of the vessel.

According to an exemplary embodiment of the disclosure the at least one gas tank of the vessel is supported by a vertically extending part of the fluid passing shaft.

According to an exemplary embodiment of the disclosure the fluid passing shaft includes a support frame and an enclosure surrounding the support frame forming a shaft.

According to an exemplary embodiment of the disclosure the enclosure is a heat insulation enclosure.

According to an exemplary embodiment of the disclosure the fluid passing shaft is arranged to vertically extend from a machine room of the vessel to outside of the vessel. The machine room is arranged to enclose one or more engines of the vessel.

According to an exemplary embodiment of the disclosure the laterally extending part includes one unit extending under each one of the engines.

According to an exemplary embodiment of the disclosure the laterally extending part includes number of units each extending under one of the engines.

According to an exemplary embodiment of the disclosure the support frame is provided with gas tight walls and the at least one gas conduit is arranged to extend inside the support frame from the at least one gas tank to the at least one gas fuel consumer.

According to an exemplary embodiment of the disclosure the fluid passing shaft includes an air inlet duct for feeding air to the gas consumers. Optionally when feeding air to an engine in the vessel the fluid passing shaft includes a heat transfer means thermally operating between the air and cold gas and thus pre-cooling the air prior to the turbocharger of the engine, increasing the efficiency of the compressor.

According to an exemplary embodiment of the disclosure an exhaust gas system of the gas consumers is outside of the fluid passing shaft, and the fluid passing shaft includes a connection interface configured to fluidly connect a heat exchanger in the gas conduit with the exhaust gas system.

According to an exemplary embodiment of the disclosure the fluid passing shaft includes an exhaust gas duct for the gas consumer.

Considerable advantages can be achieved by exemplary embodiments of the present disclosure. Separately located double wall pipes are heavy, and together with supporting, can cause, for example, vibration, insulation, and sealing issues. It can be very hard to find space for these. When integrating such systems, weight and space is saved. For retrofit solutions where a diesel machinery is retrofitted to operate as a gas engine, exemplary embodiments can provide a space saving solution.

An exemplary system according to the present disclosure enables efficient obeying of any safety and other rules. The benefits of the disclosed embodiments are obtainable in most straightforward manner in connection with gases that are lighter than the air and will evaporate upwards.

Additionally the total system weight can be lower compared to systems where piping is taken independently from a tank going through several individual pieces of equipment. Also the modularity and possibility of high grade factory assemble preparation, testing and approval at factory can shorten the assembly and installation time at site onboard.

By way of the disclosed embodiments, it is possible to arrange for heat exchange from gas streams of the engine to evaporating of gas with only minor efforts.

Exemplary embodiments of the disclosure presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated. The novel features which are considered as characteristic of the invention are set forth in particular in the appended claims.

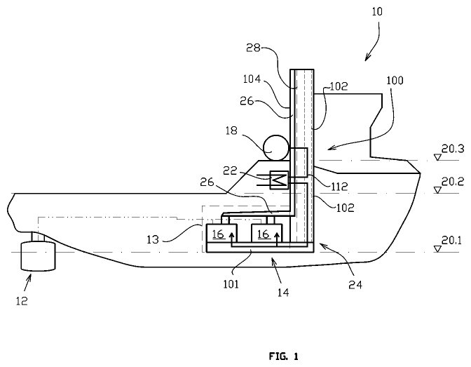

FIG. 1 depicts schematically a marine vessel 10, more particularly a work vessel, demonstrating an exemplary application of the present disclosure. The vessel is provided with an electric propulsion system 12 with separate power plant 14 for supplying power to the propulsion system 12. The power plant includes one or more internal combustion engines 16 configured to combust gaseous fuel, such as LNG, LPG or hydrogen. The vessel is provided with at least one gas tank 18 for storing the fuel in liquefied form needed for operating the engines of the power plant 14 and thus the propulsion system 12. The power plant may be configured serve power to other utilities of the vessel also, and therefore it is referred to also as a gas fuel consumer in this connection. Thus, the word gas consumer may refer to one or more engines belonging to the power plant, as well as to a boiler or a fuel cell arranged to the vessel. For example, the tank is configured to store liquefied gas such as LNG or LPG, or alike.

The marine vessel 10 has several horizontal levels 20.1, 20.2, etc., which may be referred to as decks also. It is also possible that a horizontal level is assigned between two actual decks of the vessel 10 in the sense of the present disclosure. The terms horizontal and vertical should be understood to not necessarily mean absolute horizontal or vertical directions but to be related to the orientation of the vessel. Now, the gas fuel consumers 16 are arranged at a first horizontal level 20.1, here in a machine room 13 of the vessel 10. The at least one gas tank 18 for the gas consumers 16 of the vessel is arranged at another, different horizontal level 20.3 which is referred to as a second horizontal level. The vessel 10 is provided with fuel feeding system 24 arranged to deliver fuel to the engines 16 in gaseous form. The fuel feeding system 24 connects the tank 18 to the gas consumers 16. The fuel feeding system 24 is also provided with a gas evaporation unit 22 which may be referred to therein as a heat exchanger 22 for transferring heat to the gas. The gas evaporation unit 22 is here arranged at a third horizontal level 20.2. As can be seen in the figure, the order number of the horizontal level mentioned here does not necessarily relate to the actual order of the units in the vessel. The terms horizontal and vertical are used here in respect to the hull of the vessel when the vessel floating undisturbed.

The FIG. 1 the vessel 10 depicts also a fluid passing shaft 100 according to an exemplary embodiment. The fluid passing shaft 100 is arranged to extend substantially vertically between the first horizontal level 20.1 and the second horizontal level 20.3 in the vessel. The fluid passing shaft 100 includes a support frame, using schematic reference 102 in the FIG. 1, for supporting the fluid passing shaft and an enclosure 104. The fluid passing shaft 100 is a self-supporting structure which can be manufactured separately and hauled into the vessel 10 as an entity. The fluid passing shaft forms a confined space inside the vessel 10 leading from the first horizontal level 20.1 to the second horizontal level 20.3 and further to outside the vessel 10. This way the space in the shaft via which the gas conduits are led from on horizontal level to the other may be ventilated to the surroundings. The fluid passing shaft 100 may be fastened rigidly or flexibly with thermal expansion joints allowing movement to the actual deck structure of the vessel 100.

The engines 16 are provided with an exhaust gas system 26 which is here also integrated into the fluid passing shaft 100.

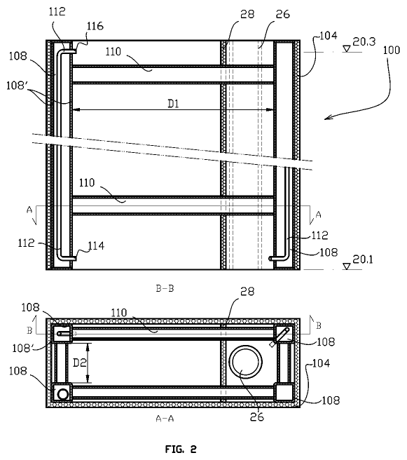

In FIG. 2 there is shown a section of the self-supporting fluid passing shaft 100 illustrating a principle of a concept disclosed herein. The fluid passing shaft 100 includes a support frame 102 formed by longitudinal beams 108 and for example, transverse girders 110. The girders 110 are used for fixing the beams 108 rigidly with each other by welding the girders between the beams. The beams 108 are arranged at a distance D1, D2 from each other. In FIG. 2 the beams have a constant distance between each other in the longitudinal direction of the fluid passage shaft (e.g., they are parallel to each other). This is an optional feature and the beams may be arranged side by side at a non-constant distance from each other, depending on the case.

The fluid passing shaft 100 is also provided with an enclosure 104 forming a confined space inside the shaft extending in the direction of beams 108. The enclosure is formed of heat insulating walls or panels. Generally speaking, the beam 108 has a length which is greater than its sideways dimension, such as width or diameter. By the insulation it is ensured for example that possible leakage of gas in liquefied phase may not cause damages to the structures of the vessel.

In the fluid passing shaft 100 there is at least one beam 108 which is hollow and is provided with gas tight walls 108′. Such a beam 108 is provided with at least one separate conduit 112 inside thereof. The conduit 112 on the left side of the sectional view B-B in the FIG. 2 extends from a longitudinal location of the shaft 100 corresponding to the first horizontal level 20.1, all that way to another longitudinal location corresponding to the second horizontal level 20.3 in FIG. 1. The conduit 112 on the right side of the sectional view B-B in FIG. 2 extends from a longitudinal location to another intermediate location now shown in FIG. 2. The conduit 112 is separated from the space of the beam 108 such that the conduit serves for normal flow channel for the gas and the wall of the beam serves as security barrier for collecting possible leakage from the conduit 112. The space inside the beam is connected to a system for receiving leakage gas (not shown) to handle any leakage appropriately. The conduit 112 has its inner space separate in gas tight manner from the inner space of the beam 108.

The conduit 112 is provided with a first connector 114 at its first end and a second connector 116 at its second end. Both the connectors 114, 116 are arranged to extend through the wall 108′ of the beam 108 such that the inner space of the beam remains gas tight at the location of the lead through, and separate from the conduit 112. The connectors are shown here in very simplified manner and it should be understood that there are various possibilities to provide the desired gas tightness and connectability conceivable within the scope of the present disclosure.

In the embodiment of the FIG. 2 the fluid passing shaft 100 includes at least four beams 108 arranged at the corners of the shaft 100 and therefore the shaft has its cross section A-A of rectangular shape.

The fluid passing shaft according to the embodiment of FIGS. 1 and 2 is provided with integrated exhaust gas duct 26 of the engines 16. In this embodiment the shaft is divided into two partial shafts by an intermediate wall 28.

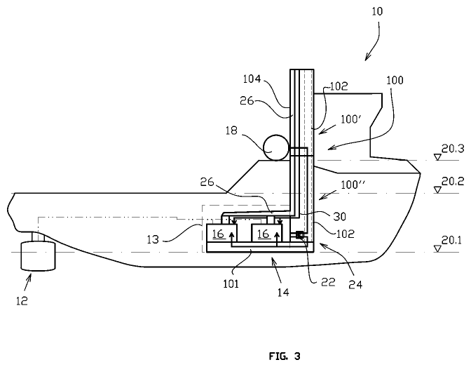

A marine vessel in the embodiment of the FIG. 3 shaft depicts a combustion air intake duct 30 arranged to extend via the shaft 100 from outside the vessel to the first horizontal level 20.1 and to the engines 16 directly or indirectly via the machine room 13 space. This makes it possible to provide a possibility to cool combustion air and at same time evaporating liquefied gas by arranging thermal exchange between the fluids.

The fluid passing shaft can be advantageously assembled from modules 100′, 100″ as is depicted in FIG. 3. The modules are arranged for example of suitable size for transportation. Also one of the modules 100″ may be configured for installation inside the vessel whereas the other one may be adapted for installation outside the vessel coping with the elements, having weather proof outer material.

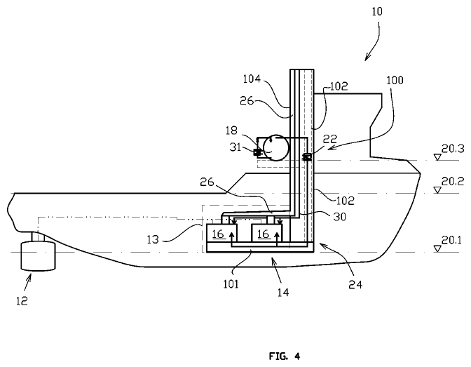

The versatility of the gas passing shaft 100 is demonstrated in FIG. 4 where a marine vessel 10 otherwise similar to that shown in FIG. 1 is shown, but where a pressure build up unit 31 and/or a gas evaporator unit 22 of the fuel feeding system 24 are positioned adjacent to or in the fluid passing shaft 100 at the second horizontal level 20.3. Additionally the at least one gas tank 18, the pressure build up system 31 and gas evaporator unit 22 of the vessel are supported by the support frame 102 of the fluid passing shaft 10. The pressure build up unit 31 is arranged to maintain a desired pressure in the gas tank 18 by controllably evaporate the liquefied gas in the tank 18 and leading the evaporated gas back to the tank 18.

The gas passing shaft 100 may be efficiently prefabricated in a factory and the installation to a vessel can include providing a space for the shaft in the vessel and hauling the shaft 100 to its place, fixing the shaft to the hull of the vessel and connecting the conduits in the shaft to the respective ones in the vessel. Therefore installation and commissioning time is saved at yard considerably.

According to an exemplary embodiment of the disclosure the fluid passing shaft can include a vertically extending part 102 and laterally extending part 101. This way the shaft may be used for passing fluids, such as fuel gas and/or combustion air in confined space into proximity of the engines. The vertically extending part 102 and the laterally extending part 101 form a common and continuous space inside the shaft 100. The laterally extending fluid passing shaft part 101 may be arranged at least partly support the engines. The laterally extending fluid passing shaft 101 is arranged under the gas consumer (i.e., the power plant). It is arranged to be a self-supporting structure which supports the engines 16 of the power plant and provides a space and channels for passing fluid channels from the vertical fluid passing shaft to the engines in lateral direction.

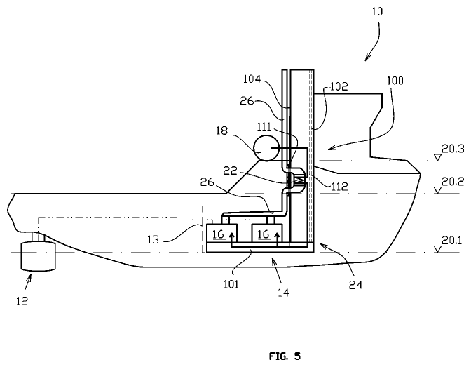

In FIG. 5 there is shown a marine vessel 10 otherwise similar to that shown in FIG. 1 but where the exhaust gas system 26 of the gas consumers 16 is outside of the fluid passing shaft 100. The heat exchanger 22 for transferring heat to the gas connected to the gas conduit 112 is arranged to cool the exhaust gas of the gas fuel consumer 16. The fluid passing shaft 100 is provided with a coupling interface 111 configured to fluidly connect the heat exchanger 22 with the exhaust gas system 26. Alternatively or additionally the fluid passing shaft may be provided with a respective coupling interface configured to fluidly connect the heat exchanger 22 with a combustion air intake duct 30 when being led to the gas consumers 14 outside the gas passing shaft.

While the invention has been described herein by way of examples in connection with what are, at present, considered to be the most preferred embodiments, it is to be understood that the invention is not limited to the disclosed embodiments, but is intended to cover various combinations or modifications of its features, and several other applications included within the scope of the invention, as defined in the appended claims. The details mentioned in connection with any embodiment above may be used in connection with another embodiment when such combination is technically feasible.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A marine vessel comprising:
at least one gas fuel consumer arranged at a first horizontal level in the vessel;
at least one gas tank for the gas fuel consumer arranged at a second horizontal level in the vessel; and
a fluid passing shaft having a vertically extending part arranged to extend between the first and the second horizontal levels, wherein the fluid passing shaft includes:
at least one gas conduit arranged to extend via the fluid passing shaft from the at least one gas tank to the at least one gas fuel consumer; and
a laterally extending part which is arranged to at least partly support the gas consumers of the vessel.

2. A marine vessel according to claim 1, wherein the fluid passing shaft is a self-supporting structure.

3. A marine vessel according to claim 1, wherein the fluid passing shaft comprises:
a vertically extending part, wherein the at least one gas tank of the vessel is supported by the vertically extending part of the fluid passing shaft.

4. A marine vessel according to claim 2, wherein the fluid passing shaft comprises:
a support frame and an enclosure surrounding the support frame forming a shaft.

5. A marine vessel according to claim 4, wherein the enclosure is a heat insulation enclosure.

6. A marine vessel according to claim 1, wherein the fluid passing shaft is arranged to vertically extend from a machine room of the vessel to outside of the vessel.

7. A marine vessel according to claim 4, wherein the laterally extending part comprises:
one unit extending under each one of the engines.

8. A marine vessel according to claim 1, wherein the laterally extending part comprises:
a number of units extending under one of the engines.

9. A marine vessel according to claim 4, wherein the support frame comprises:
gas tight walls, wherein the at least one gas conduit is arranged to extend inside the support frame from the at least one gas tank to the at least one gas fuel consumer.

10. A marine vessel according to claim 1, wherein the fluid passing shaft comprises:
an air inlet duct for feeding air to the gas consumers.

11. A marine vessel according to claim 1, wherein the fluid passing shaft comprises:
an exhaust gas duct for the gas consumer.

12. A marine vessel according to claim 1, wherein the an exhaust gas system of the gas consumers is outside of the fluid passing shaft, and the fluid passing shaft comprises:
a connection interface configured to fluidly connect a heat exchanger in the gas conduit with the exhaust gas system.
